(19) United States
(12) Patent Application Publication
(10) Pub. No.: US 2024/0098423 A1
(43) Pub. Date: Mar. 21, 2024

(54) BONE CONDUCTION LOUDSPEAKER AND HEADSET INCLUDING SAME

(71) Applicant: Million Fame Technology Limited, Shenzhen (CN)

(72) Inventor: Zhiyu Zhang, Frisco, TX (US)

(21) Appl. No.: 17/945,815

(22) Filed: Sep. 15, 2022

(51) Int. Cl. H04R 9/06; H04R 1/10

(52) U.S. Cl. CPC H04R 9/06; H04R 1/1091; H04R 2460/13

(57) ABSTRACT

A bone conduction loudspeaker is provided. The loudspeaker includes a conductive case, a diaphragm provided on one end surface of the conductive case, and a conductive plate provided on a lower end portion of the conductive case. A receiving space is defined by the conductive plate, the conductive case and the diaphragm. The receiving space accommodates a coil for generating a magnetic field and a magnetic component. The coil is fixed on an inner surface of the diaphragm.

### TECHNICAL FIELD

The disclosure relates to the technical field of acoustic conversion, and more specifically, to a bone conduction loudspeaker and a headset including same.

### BACKGROUND

Bone conduction is a mode of sound conduction, by which sound is converted into mechanical vibrations with different frequencies. Sound waves are transmitted through the human skull, bone labyrinth, inner ear lymph, spiral organ, auditory nerve and auditory center. In comparison with the traditional mode of sound conduction in which sound waves are generated through the diaphragm, bone conduction saves multiple steps of sound wave transmission, enabling clear sound reduction in noisy environments, and the sound waves don't affect people surrounding by when spreading through the air.

Bone conduction loudspeaker is a new type of electro-acoustic conversion device developed based on the sound conduction mode of bone conduction, which can convert electric signal into mechanical vibration signal. The vibration signal is then transmitted into the cochlea through human body tissue and bone, so that the user can hear the sound. The sound through bone conduction is clear and not affected by the external environment, at the same time, eardrum of user would not suffer damages. Therefore, bone conduction loudspeaker has been widely used in the field of headsets or the like. However, efficiency for existing bone conduction vibration louder speaker is not good enough, and the inductance needs to be increased for improving the efficiency when transmitting bass, the power consumption in the meantime is increased.

### SUMMARY

The technical problem to be solved by the disclosure is to provide a bone conduction loudspeaker with high conduction efficiency and low power consumption and a headset embodied with the bone conduction loudspeaker.

In order to solve the above technical problem, according to one aspect of the disclosure, a bone conduction loudspeaker is provided. The loudspeaker includes a conductive case, a diaphragm provided on one end surface of the conductive case, and a conductive plate provided on a lower end portion of the conductive case. A receiving space is defined by the conductive plate, the conductive case and the diaphragm. The receiving space accommodates a coil for generating a magnetic field and a magnetic component. The coil is fixed on an inner surface of the diaphragm.

In a further technical scheme, the conductive case includes a first case, a first bracket and a second bracket. The diaphragm is arranged on the first case. The second bracket is sleeved on the outside of the first bracket. Upper ends of the first bracket and the second bracket are arranged in the first case. One end of the conductive plate is arranged between upper ends of the first bracket and the second bracket, and the other end is arranged in the first case. The magnetic component is arranged on the first bracket. The coil is arranged on the inner surface of the diaphragm corresponding to the magnetic component.

In a further technical scheme, the first case is a hollow cylindrical body. One end surface of the cylindrical body is concave inward to form a groove near the center of the cylinder. The diaphragm is arranged in the groove. The first bracket includes a first cylinder and a retaining ring extending outward from a top edge of the first cylinder. The second bracket is sleeved on the first cylinder. One end of the conductive plate is arranged between the upper end of the second bracket and the retaining ring. The magnetic component is arranged in the first cylinder.

A further technical solution thereof is that the magnetic component includes a first magnet and a second magnet provided on the first magnet.

In order to solve the above technical problem, according to another aspect of the present disclosure, a headset including two headset units and a connector for connecting the two headset units is provided. Each of the headset units includes a housing connected to the connector and the bone conduction speaker. The diaphragm is arranged near the contact surface side of the housing contacting the user.

In a further technical scheme, the housing includes a lower case connected with the connector and a silicone plate covered on the lower case, and the bone conduction speaker is located in a receiving space formed between the lower case and the silicone plate. The diaphragm is arranged close to the low surface of the silicone plate.

In comparison with the prior art, one end surface of the conductive case is provided with a diaphragm. A receiving space is defined by the conductive plate at the lower end of the conductive case, the conductive case and the diaphragm at the end surface of the conductive case for receiving the coil and the magnet component. The alternating magnetic field changes the strength of the magnetic field of the magnetic system composed of the magnetic component and the conductive case, thereby causing the conductive plate and the diaphragm to vibrate. The diaphragm and the end surface of the conductive case in contact with the human body transmit sound to the human bone. Sound is thus induced through bone conduction, it is known that that diaphragm is used in one end surface of the conductive case to replace the end surface of the traditional conductive case in the disclosure. The bone conduction loudspeaker of the present disclosure can be vibrated and conducted through both the conductive plate and the diaphragm. The bass can be transmitted through the diaphragm when the current is not increased, thereby improving the conduction efficiency and reducing the power consumption.

### BRIEF DESCRIPTION OF DRAWINGS

FIG. 1 is a three-dimensional structural diagram of a specific embodiment of the bone conduction loudspeaker of the disclosure.

FIG. 2 is a schematic top view of the bone conduction speaker of FIG. 1.

FIG. 3 is a schematic cross-sectional view of the bone conduction loudspeaker of FIG. 1.

FIG. 4 is an exploded view of the bone conduction speaker of FIG. 1.

FIG. 5 is a structural diagram of a specific embodiment of the bone conduction headset of the disclosure.

FIG. 6 is an exploded structural diagram of the headset unit in FIG. 5.

FIG. 7 is a schematic cross-sectional view of the headset unit in FIG. 6.

### DETAILED DESCRIPTION OF THE EMBODIMENTS

In order to make the objects, technical solutions and advantages of the disclosure more clearly understood by those skilled in the art, the disclosure will be further described with reference to the drawings and embodiments.

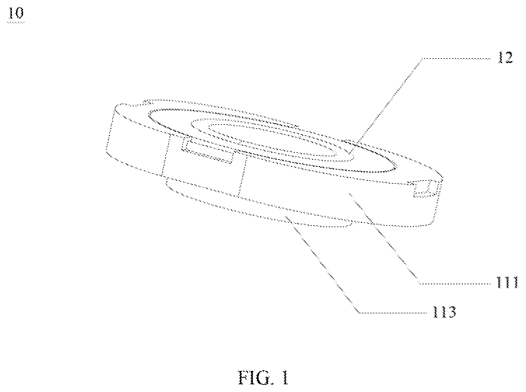

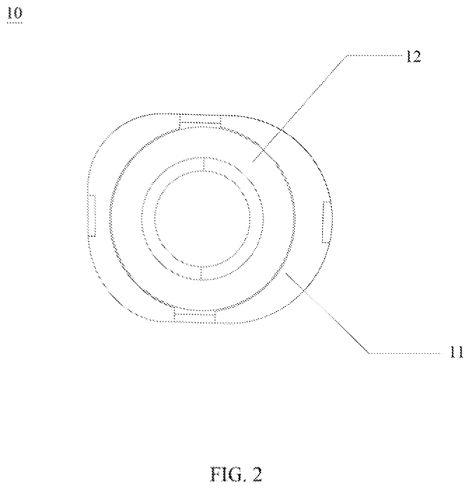

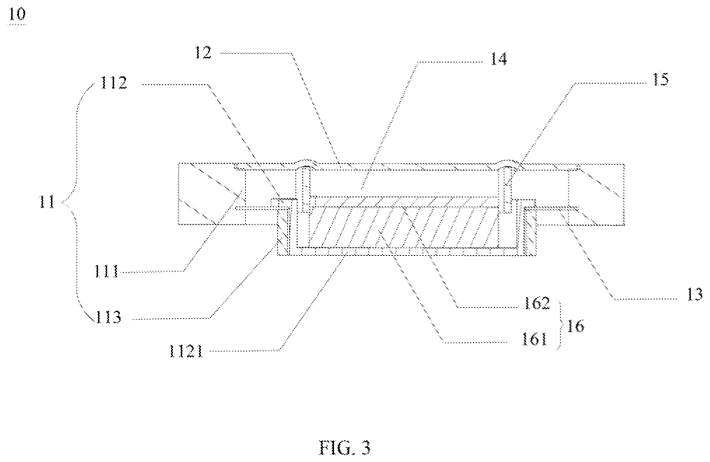

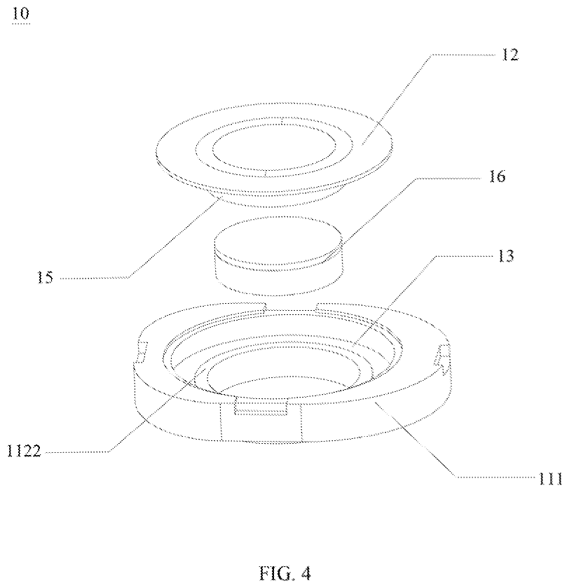

Referring to FIGS. 1 to 4, a specific embodiment of the bone conduction speaker 10 of the disclosure is shown. In the embodiments shown in the drawings, the bone conductive speaker 10 includes a conductive case 11, a diaphragm 12 arranged on one end surface of the conductive case 11, and a conductive plate 13 arranged on a lower end portion of the conductive case 11. A receiving space 14 is defined by the conductive plate 13, the conductive case 11 and the diaphragm 12 for receiving a coil 15 for generating a magnetic field and a magnetic component 16. The coil 15 is fixed on the inner surface of the diaphragm 12. Preferably, in this embodiment, the conductive case 11 may be made of a soft magnetic material such as silicon steel sheet, ferrite or iron. Based on the design, the coil 15 is energized to generate an alternating magnetic field in which the strength of the magnetic field of the magnetic system composed of the magnetic component 16 and the conductive case 11 is changed, the coil 15 is then subjected to an ampere force. Thus, the coil 15 moves back and forth in a longitudinal direction relative to the magnetic system. Since the coil 15 is fixed to the diaphragm 12, the diaphragm 12 and the conductive case 11 are driven to move. In addition, the conductive case 11 drives the conductive plate 13 at the inner low-end portion to vibrate, the diaphragm 12 and the end surface of the conductive case 11 contact with the human body for transmitting sound to the human bone. The bone conduction speaker 10 of the disclosure is transmitted through both the diaphragm 12 and the conductive plate 13, which can improve the conduction efficiency and reduce the power consumption compared to the speaker in the prior art, where sound is only transmitted through the conductive plate 13.

Specifically, in some embodiments, the conductive case 11 includes a first case 111, a first bracket 112, and a second bracket 113. The diaphragm 12 is arranged on the first case 111. The second bracket 113 is sleeved on the first bracket 112, and the upper ends of the first bracket 112 and the second bracket 113 are arranged in the first case 111. One end of the conductive plate 13 is arranged between the upper ends of the first bracket 112 and the second bracket 113. The other end is arranged in the first case 111. The magnetic component 16 is arranged on the first bracket 112. The coil 15 is provided on the inner surface of the diaphragm 12 corresponding to the magnetic component 16. Preferably, in the disclosure, the second bracket 113 and the first bracket 112 are interference fit to fix the conductive plate 13. Compared with the conventional fixing of the conductive plate 13 by the spot glue and the laser welding process, the bone conduction speaker 10 of the disclosure has a simpler process and the production difficulty is reduced. Further, the conductive plate 13 and the first house 111 are fixed by a nano injection molding process in the embodiment, the bone conduction speaker 10 of the disclosure is applied to the bone conduction headset 20, the conductive case 11 can be directly used as the outer case, and there is no need to arrange another case outside the conductive case 11. The end surfaces of the diaphragm 12 and the conductive case 11 can directly contact the human body, thereby saving materials and improving the conductive efficiency.

In this embodiment, the first case 111 is a hollow cylindrical body. One end surface of the cylindrical body is recessed inward to form a groove near the center of the cylinder, and the diaphragm 12 is provided in the groove. The first bracket 112 includes a first cylinder 1121 and a retaining ring 1122 extending outward from a top edge of the first cylinder 1121. The second bracket 113 is sleeved on the first cylinder 1121. One end of the conductive plate 13 is provided between the upper end of the second bracket 113 and the retaining ring 1122, and the magnetic component 16 is arranged in the first cylinder 1121.

Preferably, the magnetic component 16 includes a first magnet 161 and a second magnet 162 arranged on the first magnet 161. Understandably, the first magnet 161 and the second magnet 162 may be magnets made of alloy permanent magnet materials or ferrite permanent magnet materials, including but not limited to neodymium iron boron, samarium cobalt, alnico cobalt, iron chromium cobalt, aluminum iron boron, iron carbon aluminum. Ferrite permanent magnetic materials include, but are not limited to, barium ferrite, steel ferrite, manganese ferrite, lithium manganese ferrite. Based on the above design, the dual-magnet drive is adopted in the disclosure, so that the conversion efficiency of the electric sound into the mechanical vibration is higher, thereby reducing the power consumption.

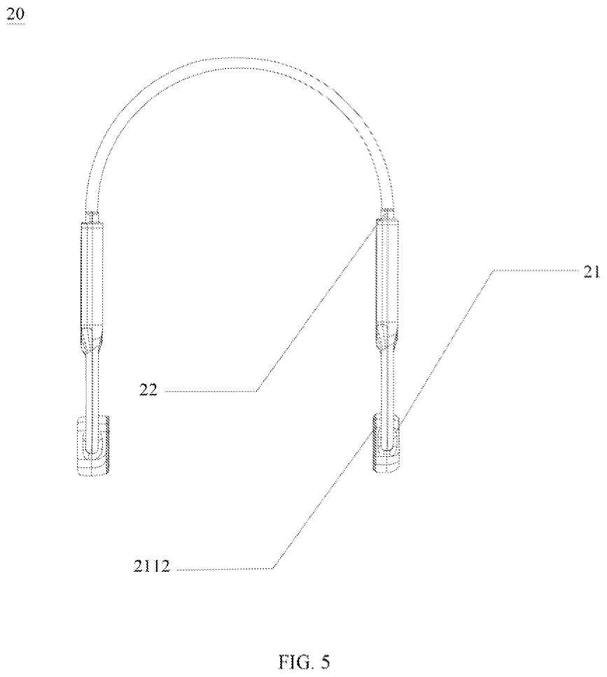

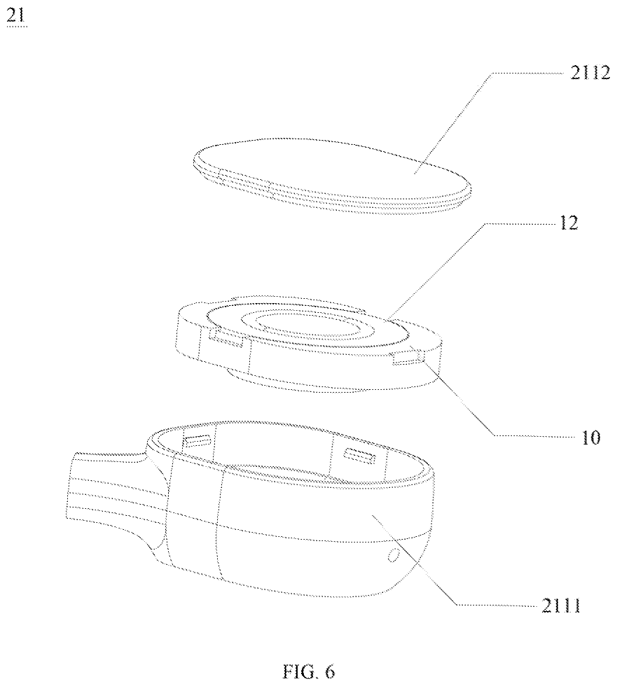

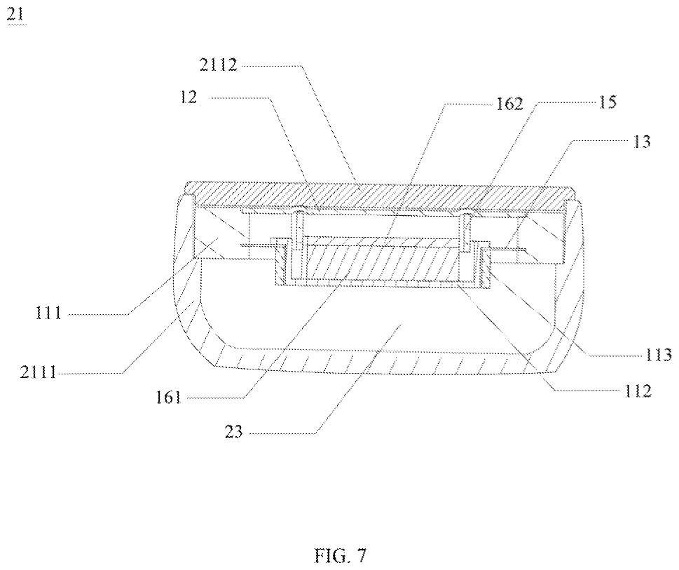

Referring to FIG. 5 to FIG. 7, a specific embodiment of the headset 20 of the present disclosure is shown. In the embodiment shown in the drawings, the headset 20 includes two headset units 21 and a connector 22 connecting the headset units 21. The headset unit 21 includes a housing connected to the connector 22 and the bone conduction speaker 10 according to the above embodiment, in which the diaphragm 12 is arranged close to the contact surface side of the housing contacting the user.

Specifically, the housing includes a lower case 2111 connected to the connector 22 and a silicone plate 2112 covering the lower case 2111. The bone conduction speaker 10 is arranged in the receiving space 23 formed between the lower case 2111 and the silicone plate 2112. The diaphragm 12 is closely attached to the lower surface of the silicone plate 2112. When the coil 15 is energized, the magnetic field intensity of the magnetic system composed of the first magnet 161, the second magnet 162 and the conductive case 11 changes, and the coil 15 is subjected to ampere forces in the magnetic field. Thus, the coil 15 moves back and forth in a longitudinal direction relative to the magnetic system. Since the coil 15 is fixed to the diaphragm 12, the diaphragm 12 and the conductive case 11 are driven to move. In the meantime, the conductive case 11 drives the conductive plate 13 at the inner lower end to vibrate, and the diaphragm 12 and the end face of the conductive case 11 contact with the human body through the silicone plate 2112, so as to transmit sound to the human bone. Sound is thus induced through bone conduction. Based on the design above, in the earphone 20 of the disclosure, the diaphragm 12 of the bone conduction speaker 10 is closely attached to the silicone plate 2112, which is more convenient to contact with the user. Compared with the conventional bone conduction earphone 20, when a same volume is played, the current required by the earphone 20 of the disclosure is smaller.

In summary, one end surface of the conductive case is provided with a diaphragm. A receiving space for receiving the coil and the magnet component is defined by the conductive plate at a lower end of the conductive case, the conductive case and the diaphragm at the end surface of the conductive case. The alternating magnetic field changes the intensity of the magnetic field of the magnetic system composed of the magnetic component and the conductive case. The coil is subjected to ampere forces in the magnetic field, so that the coil generates a longitudinal reciprocating movement with respect to the magnetic system. As the coil is fixed on the diaphragm, the vibration diaphragm and the conductive case are driven to move, and the conductive plate at the inner lower end of the vibration diaphragm and the conductive case are driven to vibrate through the conductive case. The end surfaces of the vibration diaphragm and the conductive case contact the human body to transmit sound to the human bone. In order to induce sound through bone conduction, it is known that that bone conduction loudspeaker of the disclosure is conducted through vibration of the diaphragm and the conductive plate. In the prior art, the conductive case in the bone conductive loudspeaker is mostly integrally formed of a hard material and is only conducted through the conductive plate. Compared with the conventional bone conduction loudspeaker, the bone conduction loudspeaker of the present disclosure can improve the conduction efficiency and reduce the power consumption. In addition, the conductive plate and the first casing can be fixed by the nano injection molding process of the bone conductive loudspeaker of the disclosure, so that the conductive case can be directly used as an outer case when applied to the bone conduction earphone. It is unnecessary to set a case outside the conductive case, and the end surfaces of the diaphragm and the conductive case can directly contact with the human body, thus saving materials and further improving the transmission efficiency.

The above is only a preferred embodiment of the disclosure and is not intended to limit the disclosure in any form. Those skilled in the art can make various equivalent changes and improvements on the basis of the above embodiments, and any equivalent changes or modifications made within the scope of claims shall fall within the scope of protection of the present invention.

What is claimed is:

1. A bone conduction loudspeaker, comprising a conductive case, a diaphragm arranged on one end surface of the conductive case, and a conductive plate arranged on an inner lower end of the conductive case; a receiving space is defined by the conductive plate, the conductive case and the diaphragm; the receiving space accommodates a coil for generating a magnetic field and a magnetic component; and the coil is fixed on the inner surface of the diaphragm.

2. The bone conduction loudspeaker of claim 1, wherein the conductive case includes a first case, a first bracket and a second bracket; the diaphragm is arranged on the first case; the second bracket is sleeved on an outside of the first bracket; upper ends of the first bracket and the second bracket are arranged in the first case; one end of the conductive plate is arranged between the upper ends of the first bracket and the second bracket, and another end is arranged in the first case; the magnetic component is arranged on the first bracket; the coil is arranged on the inner surface of the diaphragm corresponding to the magnetic component.

3. The bone conduction loudspeaker of claim 2, wherein the first case is a hollow cylindrical body; one end surface of the cylindrical body is concave inward to form a groove near the center of the cylinder; the diaphragm is arranged in the groove; the first bracket includes a first cylinder and a retaining ring extending outward from a top edge of the first cylinder; the second bracket is sleeved on the first cylinder; one end of the conductive plate is arranged between the upper end of the second bracket and the retaining ring; the magnetic component is arranged in the first cylinder.

4. The bone conduction loudspeaker of claim 2, wherein the magnetic component includes a first magnet and a second magnet provided on the first magnet.

5. A headset, comprising two headset units and a connector for connecting the two headset units; each of the headset units includes a housing connected to the connector and a bone conduction speaker; the diaphragm is arranged near the contact surface side of the housing contacting the user; the bone conduction speaker comprises a conductive case, a diaphragm arranged on one end surface of the conductive case, and a conductive plate arranged on an inner lower end of the conductive case; a receiving space is defined by the conductive plate, the conductive case and the diaphragm; the receiving space accommodates a coil for generating a magnetic field and a magnetic component; and the coil is fixed on the inner surface of the diaphragm.

6. The headset of claim 5, wherein the housing comprises a lower case connected with the connector and a silicone plate covering on the lower case; the bone conduction speaker is arranged in a receiving space formed between the lower case and the silicone plate; the diaphragm is arranged close to the low surface of the silicone plate.
